(19) United States
(12) Patent Application Publication
(10) Pub. No.: US 2026/0260083 A1
(43) Pub. Date: Sep. 3, 2026

(54) RADIO-FREQUENCY IDENTIFICATION READER

(71) Applicant: SATO HOLDINGS CORPORATION, Tokyo (JP)

(72) Inventors: Tai Wai Pong, St Peters (AU); Graham Murdoch, St Peters (AU); Ganesh Nagendra, St Peters (AU)

(73) Assignee: Sato Holdings Kabushiki Kaisha, Tokyo (JP)

(21) Appl. No.: 18/838,965

(22) PCT Filed: Feb. 18, 2022
(86) PCT No.: PCT/IB2022/051448

§ 371 Date: Aug. 15, 2024

(51) Int. Cl. G06K 7/10

(52) U.S. Cl. CPC G06K 7/10356; G06K 7/10415

(57) ABSTRACT

An RFID reader system (100) for determining a location of an electronically tagged item in a container with a plurality of sections comprises an RF antenna array (102) and an RFID reader (104). The RF antenna array (102) comprises an arrangement of overlapping antenna coils (108) configured to create continuous reading zones (730) individually associated with at least one section (210) of the container (200). The RFID reader (104) comprises an antenna controller (106) and a processor (110). The antenna controller (106) is configured to individually activate each antenna coil. The processor (110) is configured to receive, from the RF antenna array, a plurality of response signals associated with an activated combination of antenna coils, identify at least one reading zone responsive to the activated combination of antenna coils, and based on the identified at least one reading zone, identify a container section as the location of the item.

### TECHNICAL FIELD

The present disclosure relates, generally, to determining a location of a radio-frequency identification (RFID) tag and, more particularly, to a system and antenna arrangement for, and a method of, determining a location of an RFID tagged item.

### BACKGROUND

Radio-frequency identification (RFID) is a wireless identification method where data is electronically stored on a tag, and the data is readable by an RFID reader in order to identify, locate, and/or track the tagged items. RFID systems are not necessarily configured to provide an accurate location of a tagged item, but instead often provide a general location of a tagged item. For example, where tagged items are located in a cabinet, an RFID reader is often configured to ascertain the presence of a tag within the cabinet, but not necessarily on which shelf or in which drawer within the cabinet the tagged item is located.

RFID readers operate by generating an electrical signal, producing an electromagnetic field that interacts with the antenna coils of RFID tags to interrogate the tags and obtain identification information from the tags. The reading range of an RFID reader depends on the strength of the reading signal. Electromagnetic interference (EMI), sometimes called radio-frequency interference (RFI), is a disturbance generated by an external source that affects an electrical circuit, for example by electromagnetic induction. Because EMI may degrade the performance of electric circuits, electromagnetic compatibility (EMC) requirements and standards exist for various types of electronic equipment to limit electromagnetic emissions from the equipment. This ensures that when used as intended, such equipment does not disturb the operation of other electronics located within a certain distance.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### SUMMARY

In one aspect there is provided an RFID reader system for determining a location of an electronically tagged item in a container with a plurality of sections, the system comprising: an RF antenna array comprising an arrangement of overlapping antenna coils configured to create continuous reading zones individually associated with at least one section of the container; and an RFID reader comprising: an antenna controller configured to individually activate each antenna coil; and a processor configured to: receive, from the RF antenna array, a plurality of response signals associated with an activated combination of antenna coils, identify at least one reading zone responsive to the activated combination of antenna coils, and based on the identified at least one reading zone, identify a container section as the location of the item.

The RF antenna array may comprise: a first series of coplanar antenna coils, each coil comprising one or more coil loops, wherein the antenna coils are arranged to overlap so that the loops are aligned along a first axis, thereby generating, along the first axis, a first continuous reading zone comprising a series of interleaved reading zones generated by the coil loops of the first series; a second series of coplanar antenna coils, each coil comprising one or more coil loops, wherein the antenna coils are arranged to overlap so that the loops are aligned along a second axis, thereby generating, along the second axis, a second continuous reading zone comprising a series of interleaved reading zones generated by the coil loops of the second series, wherein the second axis is parallel to and spaced apart from the first axis so that the first and second continuous reading zones partially overlap to form a third continuous reading zone.

At least one antenna coil may comprise: a first loop arrangement comprising at least one first loop having a first current flow that causes a first magnetic field for detecting electronic tags in the near field; and a second loop arrangement conductively connected to the first loop arrangement, the second loop arrangement comprising at least one second loop having a second current flow in a rotationally opposite direction to the first current flow, the second current flow causing a second magnetic field for detecting electronic tags in the near field, wherein the first loop arrangement is configured to have a first inner area and the second loop arrangement is configured to have a second inner area so that the first magnetic field reduces the second magnetic field in the far field. The first and second magnetic fields may be in opposite directions so that a sum of the first magnetic field and the second magnetic field is substantially zero in the far field. The first loop arrangement and the second loop arrangement may form a sequence of spaced antenna loops, the spaced antenna loops producing reading zones of substantially uniform magnetic field strength.

The at least one first loop may be sized differently to the at least one second loop so that the first inner area is substantially the same as the second inner area. The sequence may comprise an uneven number of antenna loops.

The sequence may comprise two antenna loops in a figure of eight structure wherein the two antenna loops have a substantially similar inner area. The first series may comprise two overlapping figure of eight antenna coils, and the second series may comprise two overlapping figure of eight antenna coils.

The first continuous reading zone may be associated with a first and a second container section, and the second continuous reading zone may be associated with the second container section and a third container section, so that the third continuous reading zone is associated with the second container section.

The number of loops and the inner area of the loops may cause the sum of the first magnetic field and the second magnetic field to be substantially zero in the far field.

Each continuous reading zone may comprise a series of interleaved reading zones generated by the antenna coils.

The continuous reading zones are configured to have a magnetic field orientation to detect electronic tags in a predetermined upright orientation.

The RF antenna array may comprise a plurality of laterally overlapping series of antenna coils so that the series are aligned along a length of the sections of the container, and so that the array is positioned across the plurality of sections.

The antenna controller may activate each antenna coil with a plurality of power levels, and the processor may further be configured to: receive a plurality of response signals associated with the plurality of power levels respectively, and determine a container height level of the item based on the received response signals.

In another aspect there is provided a method of determining, with an RFID reader, a location of an electronically tagged item within sections of a container, the method comprising: individually activating antenna coils in an arrangement of overlapping antenna coil sets that are configured to create continuous reading zones individually associated with at least one section of the container; receiving a plurality of response signals from the arrangement of antenna coil sets, the plurality of response signals associated with an activated combination of antenna coils; identifying at least one reading zone responsive to the activated combination of antenna coils, and based on the identified at least one reading zone, identifying a container section as the location of the item.

Activating the antenna coils may comprise activating each antenna coil with a plurality of different powers; receiving the plurality of response signals comprises receiving response signals associated with each antenna coil for each of the plurality of different powers; and identifying the container section comprises: responsive to the plurality of response signals, determining in which height level of the container the item is located.

In another aspect there is provided a radio frequency (RF) antenna coil comprising: a first loop arrangement comprising at least one first loop having a first current flow that causes a first magnetic field for detecting electronic tags in the near field; and a second loop arrangement conductively connected to the first loop arrangement, the second loop arrangement comprising at least one second loop having a second current flow in a rotationally opposite direction to the first current flow, the second current flow causing a second magnetic field for detecting electronic tags in the near field, wherein the first loop arrangement is configured to have a first inner area and the second loop arrangement is configured to have a second inner area so that the first magnetic field reduces the second magnetic field in the far field.

The first and second magnetic fields may be in opposite directions so that a sum of the first magnetic field and the second magnetic field is substantially zero in the far field.

The first loop arrangement and the second loop arrangement may be substantially coplanar.

The first loop arrangement and the second loop arrangement may form a sequence of spaced antenna loops.

The sequence may comprise two antenna loops in a figure of eight structure wherein the two antenna loops have a substantially similar inner area.

The sequence may comprise an uneven number of antenna loops.

The at least one first loop may be sized differently to the at least one second loop so that the first inner area is substantially the same as the second inner area.

These and other aspects and features will now become apparent to those skilled in the art upon review of the following description of specific non-limiting embodiments in conjunction with the accompanying drawings.

Any promises made in the present description should be understood to relate to some non-limiting embodiments, and are not intended to be promises made about the invention as a whole. Where there are promises that are deemed to apply to all non-limiting embodiments, the applicant/patentee reserves the right to later delete them from the description and does not rely on these promises for the acceptance or subsequent grant of a patent in any country.

### BRIEF DESCRIPTION OF DRAWINGS

The detailed description of illustrative (non-limiting) embodiments will be more fully appreciated when taken in conjunction with the accompanying drawings in which:

FIG. 1 is a schematic representation of a non-limiting embodiment of an RFID system.

FIG. 2A shows an example non-limiting embodiment of a cabinet for which the RFID system of FIG. 1 may be used to locate an RFID tagged item within the cabinet.

FIG. 2B is a schematic representation of a tray in the cabinet of FIG. 2A, the tray holding several tagged blood bags.

FIG. 2C is a schematic representation of a blood bag having an RFID tag adhered thereto.

FIG. 2D is a schematic representation of an RFID antenna coupling with an RFID tag placed within its magnetic field.

FIG. 3 is a schematic representation of a prior art antenna configuration.

FIG. 4A is a schematic representation of a prior art figure-8 antenna configuration.

FIG. 4B is a schematic representation of a multiloop antenna coil.

FIG. 4C is a schematic representation of a prior art antenna array.

FIG. 4D illustrates the placement of the antenna array of FIG. 4C relative to sections in a region.

FIG. 5A is a schematic representation of a non-limiting embodiment of an arrangement of antenna coils.

FIG. 5B illustrates the placement of the arrangement of antenna coils of FIG. 5A relative to sections in a region.

FIG. 5C illustrates the placement of two antenna coils of FIG. 5A relative to two of the sections of FIG. 5B.

FIG. 6A illustrates the operation of a figure-8 antenna coil according to one non-limiting embodiment.

FIG. 6B illustrates the operation of another non-limiting embodiment of an antenna coil.

FIG. 6C is a schematic representation of the figure-8 antenna coil of FIG. 6A applied to container holding tagged items.

FIG. 6D is a schematic representation of the antenna coil of FIG. 6B applied to a container holding tagged items.

FIG. 7A is a schematic representation of a first non-limiting embodiment of an antenna arrangement.

FIG. 7B is a schematic representation of a second non-limiting embodiment of an antenna arrangement.

FIG. 7C illustrates the operation of the first non-limiting embodiment of FIG. 7A.

FIG. 7D illustrates the operation of the second non-limiting embodiment of FIG. 7B.

FIG. 8A is a schematic representation of another non-limiting embodiment of an antenna arrangement.

FIG. 8B illustrates operation of the antenna arrangement of FIG. 8A.

FIG. 8C illustrates operation of the antenna arrangement of FIG. 8A.

FIG. 9 is a flow diagram of a non-limiting embodiment of a method of determining a location of an item within sections of a container.

FIG. 10 is a schematic representation of a multi-shelf non-limiting embodiment of an antenna arrangement.

In the drawings, like reference numerals designate similar parts.

The drawings are not necessarily to scale and may be illustrated by phantom lines, diagrammatic representations and fragmentary views. In certain instances, details that are not necessary for an understanding of the non-limiting embodiments or that render other details difficult to perceive may have been omitted.

### DESCRIPTION

### System Overview

Reference will now be made in detail to various non-limiting embodiments of methods and systems for determining the location of an item in a storage system. It should be understood that other non-limiting embodiment(s), modifications and equivalents will be evident to one of ordinary skill in the art in view of the non-limiting embodiment(s) disclosed herein and that these variants should be considered to be within scope of the appended claims.

Furthermore, it will be recognized by one of ordinary skill in the art that certain structural and operational details of the non-limiting embodiment(s) discussed hereafter may be modified or omitted (i.e. non-essential) altogether. In other instances, well known methods, procedures, and components have not been described in detail.

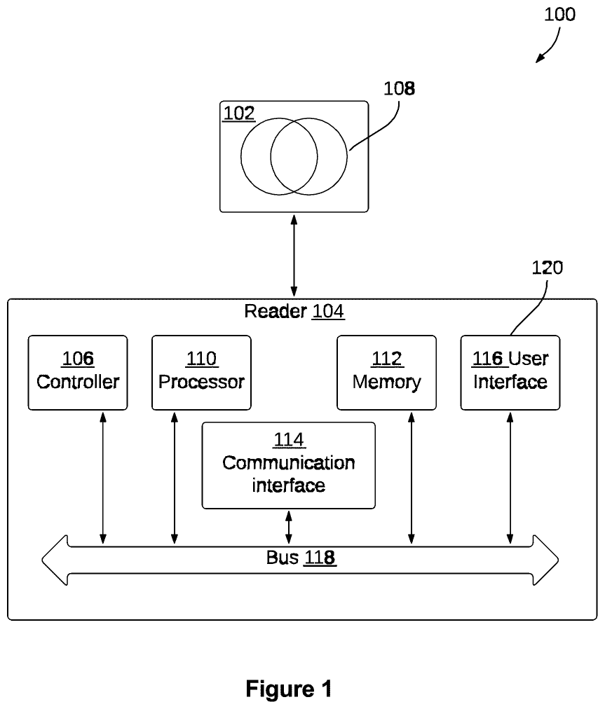

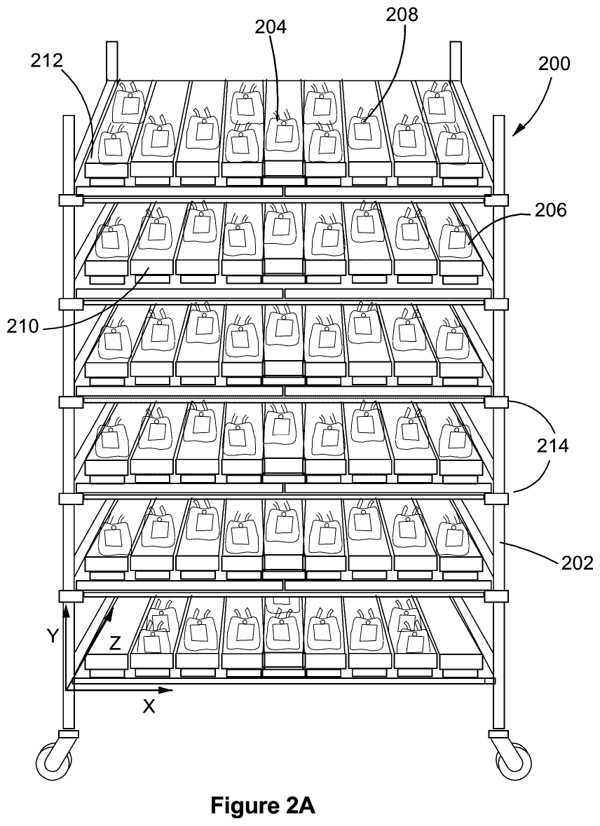

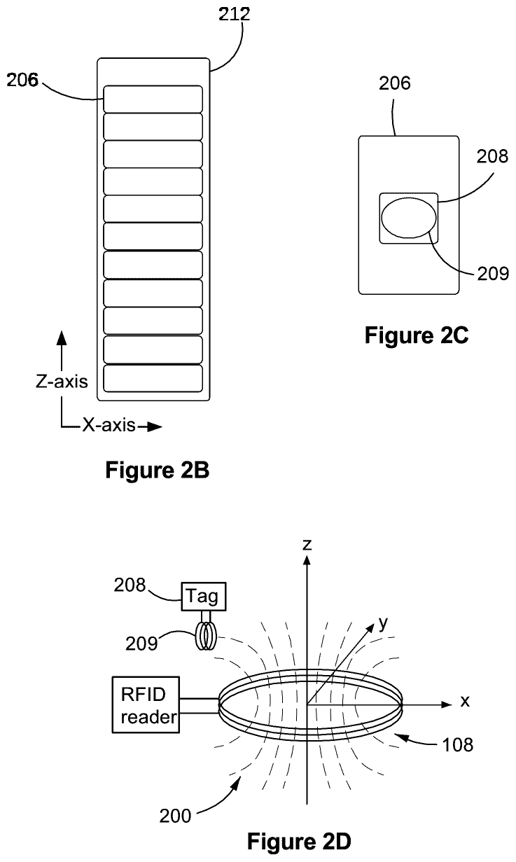

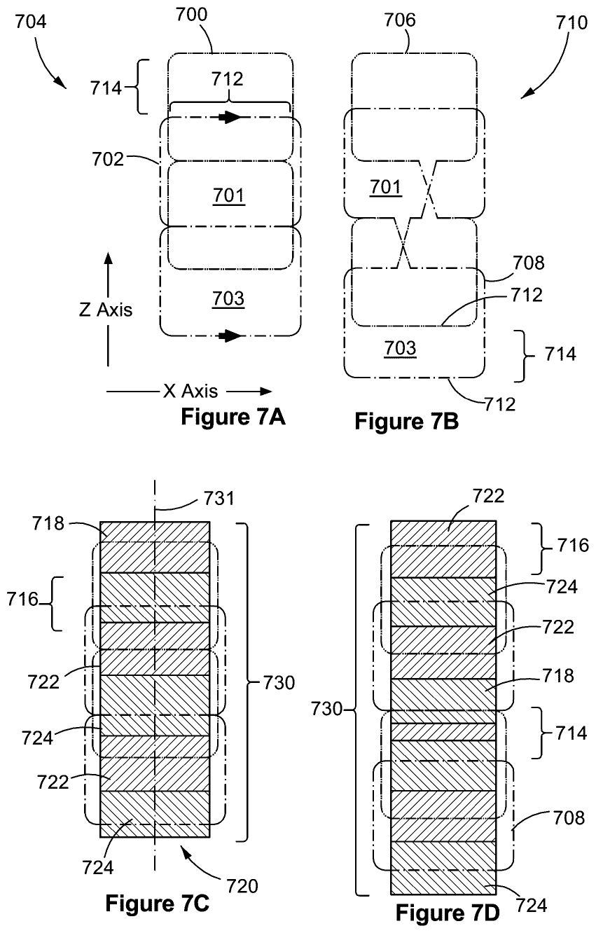

FIG. 1 of the drawings is a schematic representation of a non-limiting embodiment of a radio-frequency identification (RFID) reader system 100 for determining a location of an electronically tagged item in a container with a plurality of sections. The system 100 has a radio frequency (RF) antenna array 102 in communication with an RFID reader 104. RF antenna array 102 comprising an arrangement of overlapping antenna coils 108 configured to create continuous reading zones 730 individually associated with at least one section 210 of the container 200, as described in more detail elsewhere herein, for example with reference to FIGS. 2 and 7. The RFID reader 104 comprises an antenna controller 106 configured to individually activate each antenna coil 108, and a processor 110. The processor 110 is configured to receive a plurality of response signals from the RF antenna array 102. The response signals are associated with an activated combination of antenna coils. The processor 110 is further configured to identify at least one reading zone responsive to the activated combination of antenna coils, and to identify a container section as the location of the item based on the identified at least one reading zone.

The response signals are generated in response to one or more interrogation signals from the reader 104. The RF antenna array 102 generates at least one continuous reading zone, and each continuous reading zone is associated with at least one section of the container, as described in more detail elsewhere herein.

In some non-limiting embodiments the controller and the processor may be provided in one shared processing unit. In addition to the controller 106 and the processor 110, the RFID reader 104 includes various modules 120 that support the operation of the RFID reader 104. These modules may include one or more of: memory 112 (e.g., volatile memory, non-volatile memory, and/or other storage), a communication interface 114 supporting communication between the reader 104 and other equipment (for example in the form of a network interface controller or other interface hardware), and a user interface 116. The modules 120 of the RFID reader 104 cooperate with each other by exchanging data over a bus 118.

Referring to FIG. 2A of the drawings, an example of a container 202 that an item 204 can be located in is a trolley or cabinet 200, the items 204 in this example being plasma boxes or blood bags 206 with electronic tags in the form of RFID tags 208 affixed thereto. Each blood bag 206 is placed on a cabinet level (for example in a drawer or on a shelf 214), and each tagged item is also placed within a section 210 of the cabinet 200, each section 210 in the form of container, for example a tray 212. In this non-limiting embodiment, each shelf 214 includes a plurality of containers 212. As illustrated, the example cabinet 200 includes a plurality of levels in the form of shelves 214 (arranged vertically as labelled by the Y-axis), each shelf 214 including a plurality of trays 212. In the example non-limiting embodiment, the trays 212 are arranged in a single row along the width of the cabinet 200 (arranged horizontally as labelled by the X-axis). As illustrated in FIG. 2B, each tray 212 is longitudinal, configured to hold a plurality of RFID tagged blood bags 206 stacked in the longitudinal direction of the tray 212 across the depth of the cabinet 200 (as labelled by the Z-axis). FIG. 2C shows how each blood bag 206 has an RFID tag 208 with a tag antenna 209. In the illustrated example, where the blood bags 206 are stacked in the Z direction, the tag antennas 209 on the RFID tags 208 lie substantially in the X-Y plane. In alternative non-limiting embodiments, the trays may be arranged and/or stacked in various alternative configurations, for example each shelf may include two parallel rows of trays.

Each section 210 of the container 202 is associated with a predefined combination of antenna coils, and the processor 110 is configured to determine a first location indicator of the item 204 by determining an activated combination of antenna coils responsive to the plurality of received response signals. The predefined antenna coil combinations and example non-limiting embodiments of logic used to determine the location of a tagged item are described in more detail elsewhere herein.

FIG. 2D illustrates how an RFID antenna coil 108 couples with the tag antenna coil 209 of an RFID tag 208 placed within its magnetic field 220 (H). The magnetic field 220 is illustrated in broken lines, and the orientation of the magnetic field is shown as curving around the antenna coil 108. In a region above and below the antenna coil 108 the magnetic field curves to be almost parallel to the plane that the coil 108 lies in. The field orientation in these regions facilitates coupling with a tag antenna coil 209 that has a more or less perpendicular orientation to that of the reader's antenna coil 108. Therefore, for the example of a reader coil 108 placed in, on, below (or otherwise in the same plane as) the floor of a container's drawer, tray or shelf (the X-Y plane for the example illustrated in FIG. 2D), items with tags that are placed upright in the container so that the tags 208 are in an orientation perpendicular to the floor of the container's drawer, tray or shelf (the tag oriented in the Y-Z plane for the example illustrated in 2D, but this could be any plane parallel to the Z axis) will be able to couple with the magnetic field 220 when the tags are positioned in a region above or below the reader antenna 108. This region more or less above and/or below the reader coil is referred to herein as a “reading zone”. In contrast, if this perpendicular tag 208 is placed within the region central to the reader coil 108, where the orientation of the magnetic field 220 is substantially perpendicular to the orientation of the reader coil 108 (i.e., parallel to the Z-axis), then the magnetic field will be substantially parallel to the orientation of the tag coil 209 and coupling will be reduced or even non-existent. Consequently, such tagged items placed within this more central region or zone will not be located by the RFID reader 104. This central region is therefore considered a “dead zone”, or a region where no reading zone exists for this particular coil.

In some non-limiting embodiments described herein, the continuous reading zones are configured to have a magnetic field orientation to detect electronic tags in a predetermined upright orientation, being an orientation perpendicular to the orientation of the antenna coil, as described with reference to FIG. 2D.

### Antenna Array

In some non-limiting embodiments, the antenna coils 108 in the system 100 are arranged so that the location of an item can be accurately determined. In some non-limiting embodiments, the antenna coils 108 in the system 100 are arranged so that radio emissions are reduced so as to reduce far field distance EMI, for example to meet EMC requirements; at the same time, the antenna coils 108 are arranged to ensure sufficient field strength and operating range in the near field close to the antenna coils 108.

FIG. 3 of the drawings is a schematic representation of a prior art antenna configuration 300. In the example, two antenna coils 302 are positioned relative to four trays 304 so that each coil 302 is associated with two of the trays 304. With this configuration, if the first antenna coil 306 provides a signal to a reader indicating the presence of an RFID tag, then that RFID tag may be located in either one of the first two trays 308, 310 associated with the first antenna coil 306. Similarly, if the second antenna coil 312 provides a signal to a reader indicating the presence of an RFID tag, then that RFID tag may be located in either one of the two trays 314, 316 associated with the second antenna coil 312. With this antenna configuration 300 it is therefore not possible to accurately locate an RFID tag within one of the four trays.

Another drawback of the configuration in FIG. 3 is that the maximum power produced by each coil is limited by EMC regulations which provide limitations for electromagnetic emissions at certain distances from electronic equipment. One solution is to configure the two coils 302 so that the current in one coil flows in an opposite direction to the current in the other coil, thereby resulting in magnetic fields that cancel each other out in the far field. However, if both coils are activated at the same time to result in such a net zero far field, then it is impossible to distinguish in which of the four trays 304 a tagged item is located.

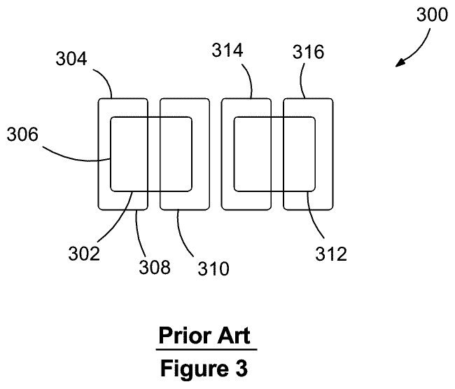

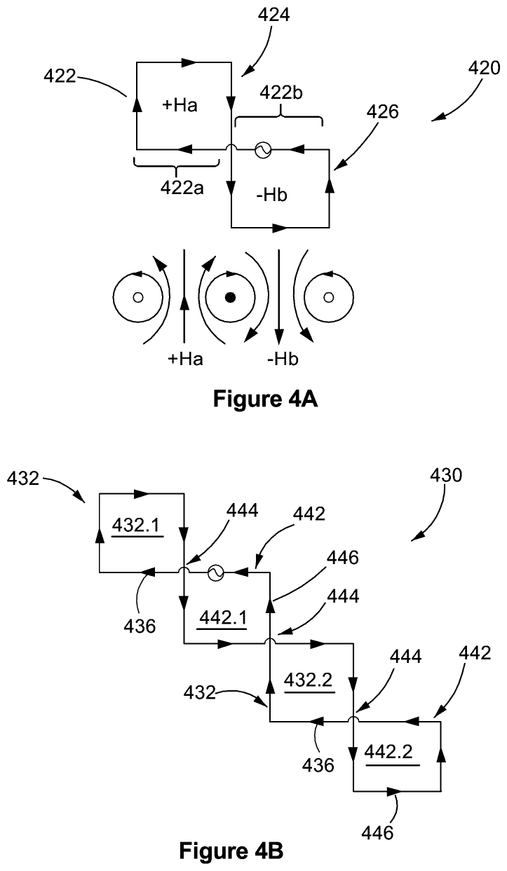

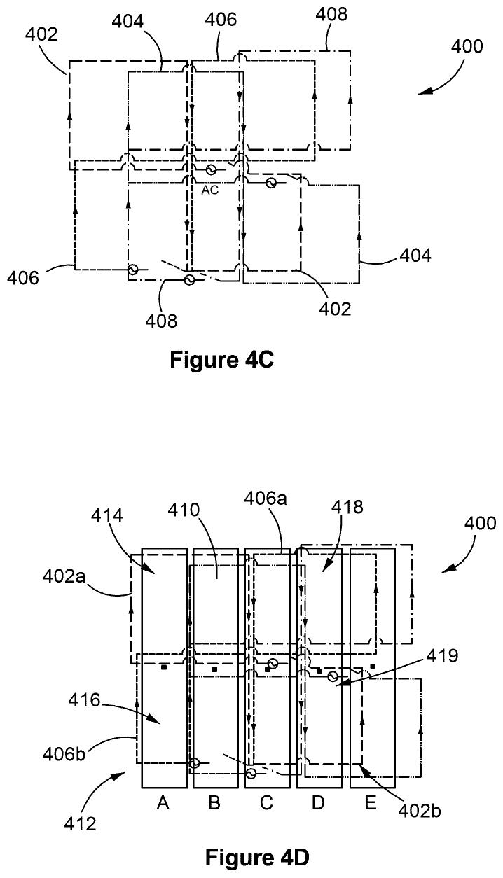

FIG. 4A of the drawings shows a non-limiting embodiment of an antenna configuration 420 in which an antenna coil 422 is arranged to form a figure-8 loop having a first loop 424 and a second loop 426. In this configuration 420, the two loops 424, 426 are positioned to be as far apart as practicable to avoid the placement of portions 422 of the coil, such as portions 422a and 422b, adjacent to one another thereby minimising near field cancelling. In this way, this figure-8 antenna coil 422 is able to provide additional conducting portions (compared to each of coils 302 in FIG. 3 for example) to improve the accuracy of the antenna operation.

The antenna coil 422 is configured to consist of two loops 424, 426 arranged in a figure-8 antenna structure with counter rotating currents in each loop. This results in two benefits. Firstly, the loops are sufficiently separated to optimise field strength and operating range in the near field close to the loops. Secondly, the current in the two loops 424, 426 flows in opposite directions which provides a cancelling of the magnetic field in the far field: Ha−Hb≈0. This is done in order to meet global emission regulation (EMC) requirements.

Various non-limiting embodiments of antenna arrays are described herein wherein the number of antenna coil loops and the inner area of the loops cause the sum of the first magnetic field and the second magnetic field to be reduced or even substantially zero in the far field.

FIG. 4B illustrates a non-limiting embodiment of a multiloop antenna coil. The radio frequency (RF) antenna coil 430 has a first loop arrangement 432 comprising at least one first loop 432.1 (and in this example comprising two loops 432.1, 432.2). The loops of the first loop arrangement 432 have a first current flow 436 that causes a first magnetic field +H for detecting electronic tags in the near field. The antenna coil 430 also has a second loop arrangement 442 conductively connected to the first loop arrangement 432 (at connections 444). The second loop arrangement 442 comprises at least one second loop 442.1 (and in this example comprising two loops 442.1, 442.2) having a second current flow 446 in a rotationally opposite direction to the first current flow 436, the second current flow 446 causing a second magnetic field −H for detecting electronic tags in the near field. The first loop arrangement 432 is configured to have a first inner area A1 and the second loop arrangement is configured to have a second inner area A2 so that the first magnetic field +H reduces the second magnetic field −H in the far field. The dimension of the first inner area A1 is the total of the inner areas of the first loops 432.1, 432.2. The dimension of the second inner area A2 is the total of the inner areas of the second loops 442.1, 442.2.

Magnetic field strength H=B/μ, where B is the magnetic flux density and μ is the permeability of the relevant material (e.g. air). Magnetic flux Φ through a surface is the surface integral of the normal component of the magnetic field B over that surface: Φ_{B}=∫∫BdA. Therefore, the total magnetic flux depends on the total area, i.e. A1 or A2 in this example. When A1 and A2 are similar or equal, A1≈A2, then the total magnetic flux in the two respective directions will also be similar or equal. Therefore, for coils with loops that are a similar size, an even number of loops would result in a substantially far field magnetic field. Alternatively, where the loops are varying sizes, then the number of loops will not necessarily determine the total far field magnetic field; instead the total area bound by loops having a first current flow in a first direction being substantially similar to the total area bound by loops having a second current flow in a second opposite direction will result in the total far field magnetic field being reduced, or even being substantially zero.

Therefore, in some non-limiting embodiments of a double or multiloop antenna coil described herein, the first and second magnetic fields are in opposite directions so that a sum of the first magnetic field and the second magnetic field is substantially zero in the far field. To make it easier to achieve this, some non-limiting embodiments are configured so that the first loop arrangement and the second loop arrangement are substantially coplanar.

In a multiloop antenna coil, the first loop arrangement comprises all the loops that contribute to the first magnetic field, and second loop arrangement comprises all the loops that contribute to the second magnetic field. The first loop arrangement and the second loop arrangement form a sequence of antenna loops. The sequence may comprise an even or an uneven number of antenna loops.

In some non-limiting embodiments, at least one first loop is sized differently to at least one second loop so that the first inner area is substantially the same as the second inner area. However, the loops may be of similar or of different sizes, resulting in similar or different inner areas for individual loops; nevertheless, even with different individual inner areas, the total inner area of the first and second loop arrangements may still be similar or equal.

FIG. 4C of the drawings illustrates a non-limiting embodiment of an array 400 of figure-8 antennas: a first antenna 402, a second antenna 404, a third antenna 406 and a fourth antenna 408. Each figure-8 antenna includes two loops, the loops are configured to avoid the placement of portions of the coil adjacent to one another.

FIG. 4D illustrates the placement of the antenna array 400 relative to sections 410 in a region 412, for example relative to trays on a shelf. The first loop of each coil is positioned relative to a first pair of trays, and the second loop of each coil is positioned relative to a second, different pair of trays.

In the example, the antenna array 400 is positioned relative to the five blood trays (labelled A, B, C, D and E) so that each tray is associated with a certain combination of the antenna coils. For example, the top halves of trays A and B are located in a first zone 414 defined by the first loop 402a of the first antenna 402. The bottom halves of trays A and B are located in a second zone 416 defined by the second loop 406b of the third antenna 406. Similarly, the top halves of trays C and D are located in a third zone 418 defined by the first loop 406a of the third antenna 406, while the bottom halves of trays C and D are located in a fourth zone 419 defined by the second loop 402b of the first antenna 402. As shown in Table 1, an RFID tag detected by the first and third antenna coils 402, 406, can therefore lie within any one of trays A, B, C or D.

TABLE 1
Coil-section mapping

| | Section A | Section B | Section C | Section D | Section E |
|---|---|---|---|---|---|
| Coil 1 (402) | ✓ | ✓ | ✓ | ✓ | |
| Coil 2 (404) | | ✓ | ✓ | ✓ | ✓ |
| Coil 3 (406) | ✓ | ✓ | ✓ | ✓ | |
| Coil 4 (408) | | ✓ | ✓ | ✓ | ✓ |

The antenna array 400 is only able to provide a coarse location identification of tags in the trays, and cannot identify an accurate location such as one particular tray that a tagged item is in.

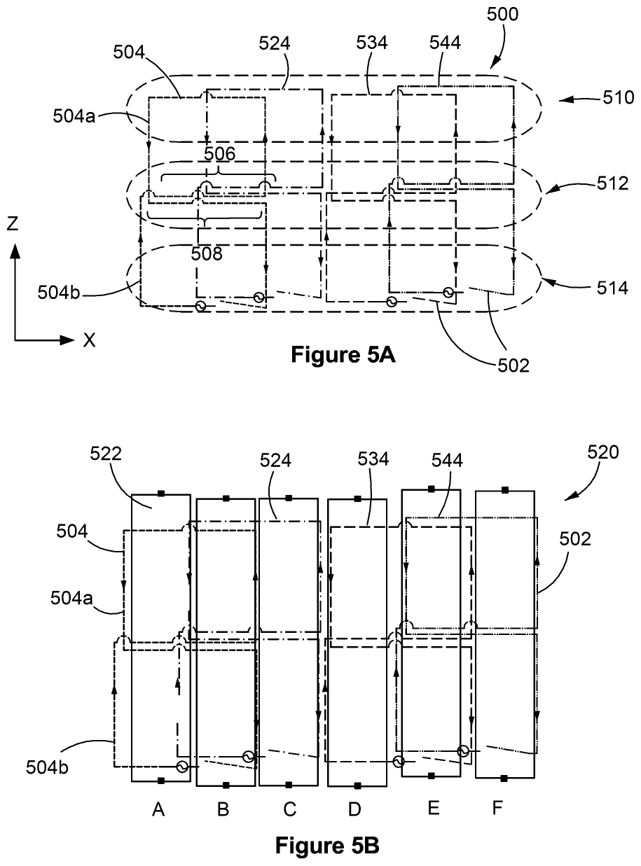

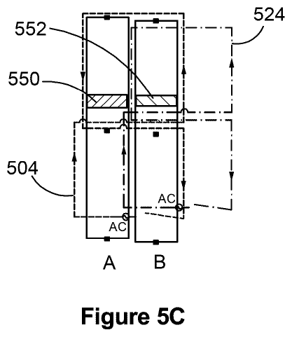

FIG. 5A of the drawings shows a non-limiting embodiment of a novel arrangement of antenna coils 500. The arrangement of antenna coils comprises a series of antenna coils 502, each coil comprising a first loop having a first current flow and a second loop having a second current flow in a rotationally opposite direction to the first current flow. In contrast to the antenna array 400 illustrated in FIG. 4C, the two loops of each coil are configured so that they are positionable relative to the same pair of trays. Referring to the first antenna coil 504 for example, the first loop 504a lies adjacent to the second loop 504b, a portion 506 of the first loop 504a positioned alongside a portion 508 of the second loop 504b so that the direction of the current flow in both portions is the same.

In this example there are four coils 504, 524, 534, 544, and the arrangement 500 is such that a first reading zone 510 is created across a first edge of the arrangement, a second reading zone 512 is created across a more or less central region of the arrangement of antenna coils 500, and a third reading zone 514 is created across a second opposite edge of the arrangement. Referring to the axes illustrated in FIG. 2A, the conductive portions of the antenna coils that are positioned substantially in the direction of the X-axis, result in a magnetic field above and below the conductive portions and within the reading zones that is substantially in the direction of the Z-axis within the trays. A magnetic field oriented in this way will couple with (and therefore enable the reader 104 to read) RFID tag antennas that are positioned substantially in an X-Y plane.

FIG. 5B of the drawings illustrates the placement of the arrangement of antenna coils 500 relative to six sections 522 in a region 520, such as six trays on a shelf (labelled A to F). Each coil 502 is positioned within the region 520 so that both loops of the coil are associated with the same at least one section 522 (this example non-limiting embodiment showing two sections associated with both loops of the same coil). For example, the first loop 504a and the second loop 504b of the first figure-8 antenna coil 504 are both associated with trays A and B, contributing to the reading zones 510, 512, 514 that lie across the top, middle, and bottom of trays A and B as illustrated in FIG. 5B.

The arrangement of antenna coils 500 comprises an overlapping series of antenna coils 502 to form a predefined combination of antenna coils associated with each section. Each coil is activated one at a time so that the reader 104 can ascertain which tags lie within an reading zone associated with a predefined combination of one or more antennas. In this example non-limiting embodiment the predefined associations comprise either a single antenna, or a combination of two antennas. The mapping of antenna coils to sections means that each section can be uniquely identified as a tag location, as described in Table 2:

TABLE 2
Coil-section mapping

| | Section | Section | Section | Section | Section | Section |
|---|---|---|---|---|---|---|
| | A | B | C | D | E | F |
| Coil 1 (504) | ✓ | ✓ | | | | |
| Coil 2 (524) | | ✓ | ✓ | ✓ | | |
| Coil 3 (534) | | | | ✓ | ✓ | |
| Coil 4 (544) | | | | | ✓ | ✓ |

Advantageously, in this configuration two antenna coils can be used to uniquely identify a location within three trays. In other words, the number of antenna coils is less than the number of trays.

Referring to FIG. 5C, in this example non-limiting embodiment a first RFID tag 550 in tray A and a second RFID tag 552 in tray B can both be read by the first antenna coil 504. The second antenna coil 524, however, cannot read the first RFID tag 550, but can read the second RFID tag 552 that lies in tray B. Hence, by cycling through each figure-8 antenna one at a time, based on which antenna identifies a tag, the logic as defined in Table 2 can be used to determine that the first RFID tag 550 is located in tray A and the second RFID tag 552 is located in tray B.

Advantageously, in the non-limiting embodiment illustrated in FIGS. 5A-5C, each figure-8 coil results in a far field effect that reduces the total EMC due to the opposite directions of the magnetic field in each half of the coil. At the same time, in the near field the magnetic field associated with each loop of the coil is still enough to identify tags within a reading range from the coils.

A disadvantage of this configuration is that in the near field the resulting RF reading surface is not consistent across the conductive portions because a stronger field is created in the central region than at the two ends. The field in the middle reading zone 512 will be stronger and have a larger range than the field in the edge reading zones 510, 514 due to the two adjacent conductive portions (for example portion 506 of the first loop 504a positioned alongside portion 508 of the second loop 504b as illustrated in FIG. 5A). For some applications this may be beneficial, for example if it is known that the RFID tags in the tray are likely to be located within this central zone. However, for other applications the inconsistent strength of the magnetic field at different positions in the tray may not be desired. One consequence, for example, may be that the larger, middle reading zone 512 may extend to the shelves above and/or below the shelf that the antenna arrangement 500 is intended for, and for some applications this may not be beneficial.

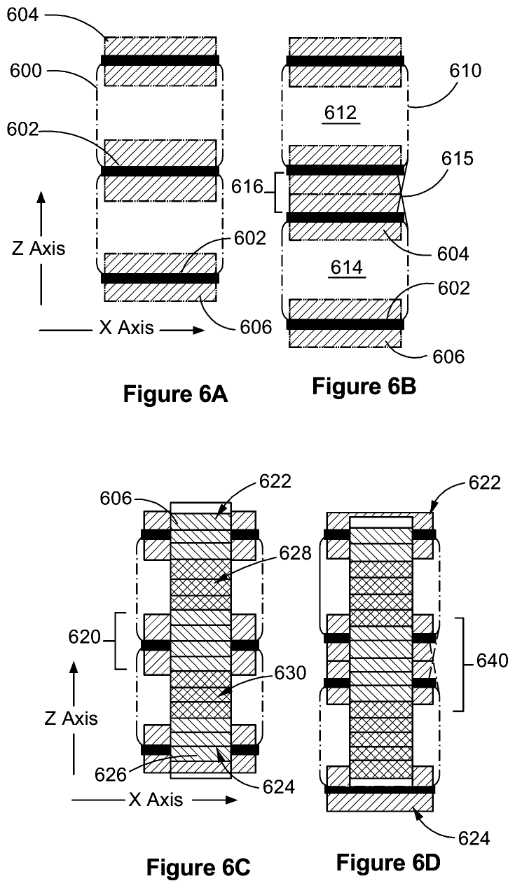

FIG. 6A of the drawings illustrates the operation of one figure-8 antenna coil 600 (such as the first antenna coil 504 of FIG. 5A). The conductive portions 602 of the antenna coil 600 that extend in the direction of the X-Axis produce a magnetic field 604 around each conductive portion 602, creating a reading zone 606 above and below the conductive portions 602 that is able to read the tag antennas 209 on the RFID tags 208 that lie substantially in the X-Y plane.

FIG. 6B of the drawings illustrates the operation of another non-limiting embodiment of an antenna coil 610. The first loop arrangement and the second loop arrangement form a sequence of spaced antenna loops, wherein the sequence comprises two antenna loops in a figure of eight structure and the two antenna loops have a substantially similar inner area. In this example the two loops 612, 614 of the figure-8 coil are spaced apart by a distance 616. The two loops of the coil may be conductively connected in various ways, and in the exemplary non-limiting embodiment the antenna coil 610 is B-shaped with the connection between the first and second loop positioned to one side (and not in the middle) thereby forming a spectacle-shaped structure. In this non-limiting embodiment, the antenna coil 610 is asymmetrical, with the connection 615 between the two spaced apart loops 612, 614 being offset, positioned along one longitudinal side of the antenna coil 610. The conductive portions 602 of the antenna coil 610 that extend in the direction of the X-Axis produce a magnetic field 604 around each conductive portion 602, creating reading zones 606 being regions in which RFID tags can be located by the antenna coil 610.

As illustrated in FIG. 6C, the figure-8 antenna coil 600 provides three reading zones 606, the central zone 620 slightly larger than the edge zones 622, 624. This is illustrated notionally as the edge zones 622, 624 being sized to read three tagged items 626 while the central zone 620 (due to two parallel and adjacent conductive portions) is sized to read four tagged items 626. In the exemplary non-limiting embodiment, items 626 located outside of the reading zones, i.e., in region 628 and region 630, cannot be read by the figure-8 antenna coil 600 because the magnetic field is perpendicular to the plane that the antenna coil is in (i.e., the X-Z plane).

As illustrated in FIG. 6D, the antenna coil 610 with spaced apart loops advantageously not only has a larger central reading zone 640, but the field strength in the reading zone is more uniform (i.e. not stronger in the central reading zone compared to the edge reading zones). In FIG. 6D the central reading zone 640 is illustrated as being notionally sized to be able to read about six tagged items 626, i.e., double the size of the edge zones 622, 624.

### Overlapping Antenna Coil Array

In some non-limiting embodiments, one antenna coil (such as the non-limiting embodiment illustrated in FIG. 6A or the non-limiting embodiment illustrate in FIG. 6B) may be shaped and sized so that the two coil loops have substantially parallel conductive portions in the X-direction that are spaced apart such that a continuous reading zone can be provided by a single coil, although the magnetic field will change in direction through the reading zone as the field curves around the conductor.

In other non-limiting embodiments, where the coil is configured so that the resulting reading zone is smaller than the area that needs to be read (for example smaller than a tray holding tagged items), then two or more coils may be arranged to cover the required area. This may be the case, for example, where a magnetic field is required in the Z direction, which cannot be obtained in the centre of a coil positioned in the X-Z plane.

Referring to FIG. 7A and FIG. 7C of the drawings, a radio frequency (RF) antenna array 704 comprises at least one first set of coplanar antenna coils 700, 702, each antenna coil comprising a first loop 701 having a first current flow and a second loop 703 having a second current flow in a rotationally opposite direction to the first current flow so that the first current flow causes a first magnetic field (H1) for detecting electronic tags in the near field and the second current flow causes a second magnetic field (−H2) for detecting electronic tags in the near field. The first and second magnetic fields are in opposite directions so that a sum of the first magnetic field and the second magnetic field is substantially zero in the far field: Hₜₒₜ=H1−H2≈0. The antenna coils 700, 702 are arranged to overlap so that the loops are aligned along a first axis 731, thereby generating a first continuous reading zone 730 along the first axis.

The first continuous reading zone 730 comprises a series 720 of interleaved reading zones 718 generated by the antenna coils, and in this example generated by the first loop 701 and the second loop 703 of each antenna coil 700, 702.

Referring to the coil arrangement 710 illustrated in FIG. 7B and FIG. 7D, the first loop 701 and the second loop 703 of each antenna coil 706, 708 may be spaced apart, thereby producing reading zones 718 of substantially uniform magnetic field strength.

The antenna coils may be configured so that the two coil loops have substantially parallel conductive portions with reading zones that are spaced apart. In some non-limiting embodiments, each coil loop is sized so that the conductive portions that cross the section (i.e., horizontal across a tray) are spaced apart by a distance that is approximately double the width of a reading zone. This spacing is useful where two similar coils are arranged to overlap as illustrated in FIG. 7A: a first figure-8 coil 700 and a second figure-8 coil 702 are arranged to overlap, forming a figure-8 coil arrangement 704. Similarly, as illustrated in FIG. 7B, a first coil 706 and a second coil 708 having spaced apart loops are arranged to overlap, forming a coil arrangement 710. In both these non-limiting embodiments, the coils overlap in an arrangement so that the conductive portions 712 of the two coils are spaced apart by a distance 714 that is approximately the same as the width 716 of a reading zone 718, as illustrated in FIG. 7C and FIG. 7D. This spacing allows for a continuous series 720 of reading zones 718. In both these arrangements 704, 710, the first coil 700, 706 creates a first series of reading zones 722, and the second coil 702, 708 creates a second series of reading zones 724. The coil arrangements 704, 710 are formed by first and second overlapping coils so that the first series and second series of readings zones 722, 724 are interleaved thereby creating a continuous RFID antenna reading zone 730 as shown in FIGS. 7C and 7D.

The antenna coils are switched sequentially, with one coil active at any point in time. For example, referring to coil arrangement 710, the first coil 706 will be activated first, thereby activating the first series of reading zones 722 which enables the RFID reader to detect tagged items located within the first series of reading zones 722. After this, the second dog bone coil 708 will be activated, thereby activating the second series of reading zones 724 which enables the RFID reader to detect tagged items located within the second series of reading zones 724. In this way, the RFID reader is able to unambiguously identify the location of a tagged item as being either within the first series of reading zones 722 or within the second series of reading zones 724.

The continuous RFID antenna reading zone 730 means that tagged items anywhere in the section where the antenna array is located can be identified (e.g., tagged blood products on a tray with an overlapped antenna array placed along the length of the tray).

As can be seen in FIG. 7D, one of the advantages of the figure-8 configuration with spaced apart loops is that the same number of antennas can cover a larger reading area, or put another way: less antenna coils are required to cover the same RFID reading area.

In FIG. 7B, the first loop arrangement and the second loop arrangement form a sequence of spaced antenna loops, the spaced antenna loops producing reading zones of substantially uniform magnetic field strength. In this example, the first loop 701 and the second loop 703 are the same size, resulting in a first inner area that is substantially the same as the second inner area. In multiloop antenna coils, however, at least one first loop may be sized differently to at least one second loop, but in total the loops would be sized so that the sum of all the individual loop inner areas is such that the first inner area (in total) of the first loop arrangement will be substantially the same as the second inner area (in total) of the second loop arrangement. In such multiloop coils, the sequence can have either an even number of antenna loops or an uneven number of antenna loops. In the example illustrated in FIGS. 7A to 7D, the sequence comprises two antenna loops in a figure of eight structure wherein the two antenna loops have a substantially similar inner area.

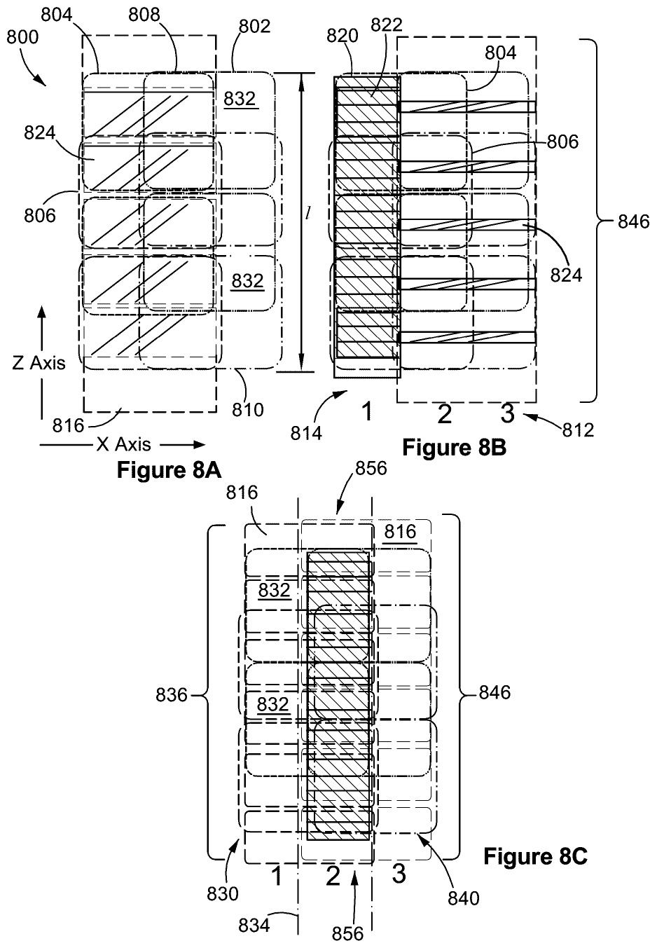

As illustrated in FIGS. 8A-8C for example, the RF antenna array 800 comprises a first series 830 of coplanar antenna coils 802, each coil comprising one or more coil loops 832, wherein the antenna coils 802 are arranged to overlap so that the loops 832 are aligned along a first axis 834, thereby generating, along the first axis, a first continuous reading zone 836 comprising a series of interleaved reading zones 816 generated by the coil loops of the first series 830. The antenna array 800 also comprises a second series 840 of coplanar antenna coils 802, each coil comprising one or more coil loops 832, wherein the antenna coils are arranged to overlap so that the loops are aligned along a second axis 844, thereby generating, along the second axis, a second continuous reading zone 846 comprising a series of interleaved reading zones 816 generated by the coil loops of the second series 840. The second axis 844 is parallel to and spaced apart from the first axis 834 so that the first and second continuous reading zones partially overlap to form a third continuous reading zone 856.

In the examples of FIGS. 7A-7D and FIGS. 8A-8C, the antenna coils comprise a first loop arrangement comprising a first loop having a first current flow that causes a first magnetic field for detecting electronic tags in the near field, and a second loop arrangement conductively connected to the first loop arrangement, the second loop arrangement comprising a second loop having a second current flow in a rotationally opposite direction to the first current flow, the second current flow causing a second magnetic field for detecting electronic tags in the near field. The first loop arrangement is configured to have a first inner area and the second loop arrangement is configured to have a second inner area so that the first magnetic field reduces the second magnetic field in the far field. In some non-limiting embodiments, the first and second magnetic fields are in opposite directions so that a sum of the first magnetic field and the second magnetic field is substantially zero in the far field.

In the example of FIGS. 8A-8C, the RF antenna array 800 comprises a plurality of laterally overlapping series 830, 840 of antenna coils 802 so that the series 830, 840 are aligned along a length l of the sections 812 of the container, and so that the array 800 is positioned across the plurality of sections 812 (in the X direction as indicated by the X-axis in FIG. 8A).

In this non-limiting embodiment, the first series 830 comprises two overlapping figure of eight antenna coils 804, 806, and the second series 840 comprises two overlapping figure of eight antenna coils 808, 810. The first continuous reading zone 836 is associated with the first container section 1 and the second container section 2, and the second continuous reading zone 846 is associated with the second container section 2 and the third container section 3, so that the third continuous reading zone 856 is associated with the second container section 2.

FIG. 8A illustrates a non-limiting embodiment of an antenna array 800 comprising a plurality of overlapping figure-8 antenna coils 802. This example non-limiting embodiment includes four coils 804, 806, 808, 810, arranged such that the three sections 812 in the region 814 are each associated with a combination of reading zones 816 created by the antenna array 800. Sections 812 (which may be, for example, a plurality of trays on a shelf of a cabinet) are identifiable based on unique combinations of coils as described in Table 3:

TABLE 3
Coil-section mapping

| | Section 1 | Section 2 | Section 3 |
|---|---|---|---|
| Coil 1 (804) | ✓ | ✓ | |
| Coil 2 (806) | ✓ | ✓ | |
| Coil 3 (808) | | ✓ | ✓ |
| Coil 4 (810) | | ✓ | ✓ |

In fact, as the coils function in pairs to ensure continuous coverage along the length of a tray (as described with reference to FIGS. 7A-7D), the coil-section mapping of Table 3 may be described as a coil-pair section mapping as shown in Table 4:

TABLE 4
Coil-pair section mapping

| | Section 1 | Section 2 | Section 3 |
|---|---|---|---|
| Coil pair 1 (804, 806) | ✓ | ✓ | |
| Coil pair 2 (808, 810) | | ✓ | ✓ |

Two coil pairs are used to unambiguously identify the location of tags in three sections. In some non-limiting embodiments the overlapping coil configuration may comprise three or more coils, so that two antenna coil sets are used to identify the location of tags in three sections. In some non-limiting embodiments, three or more coil sets may be used to identify the location of tags in three or more sections.

FIG. 8B shows a tray 820 placed in section 1 at the left side of the antenna array 800. The tagged items 822 in this tray 820 are read by the first coil 804 and/or the second coil 806 in the first coil pair. Hence, if only the first coils 804 and/or the second coil 806 receive response signals from tag antennas, the system 100 determines that the tagged items are located in section 1.

In FIG. 8C, the tray 820 is placed in the centre, section 2. The tagged items 822 in section 2 are detected by all four antennas 802.

In some non-limiting embodiments, as illustrated in FIG. 8C, the reading zones 816 do not overlap. Referring to Table 3, in this non-limiting embodiment tagged items 822 in tray 820 will be read by either the first coil 804 or the second coil 806. Similarly, for section 3, tagged items 822 will be read by either the third coil 808 or the fourth coil 810. For section 2, tagged items 822 will be read by both the first coil 804 and the third coil 808, or they will be read by the second coil 806 and the fourth coil 810.

In other non-limiting embodiments, as illustrated in FIG. 8B, the reading zones 816 overlap partially. Tagged items located in the overlap zones 824 are read by more than one coil.

In other non-limiting embodiments, as illustrated in FIG. 8A, the reading zones may overlap so that all tagged items 822 are read by more than one coil 802.

### Method Overview

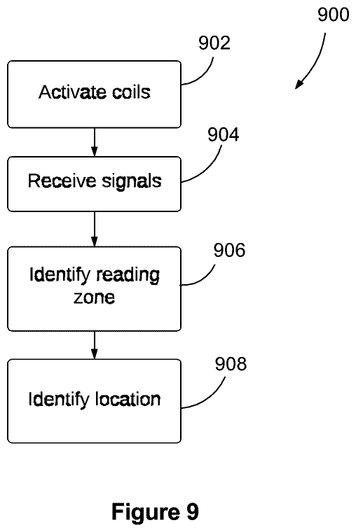

FIG. 9 shows a flow diagram of a non-limiting embodiment of a method 900 of determining a location of an electronically tagged item. The method 900 determines, with an RFID reader (for example an RFID reader comprising two or more overlapping sets of antenna coils), a location of the item within sections of a container. The method comprises, at 902 individually activating antenna coils in an arrangement of overlapping antenna coil sets that are configured to create continuous reading zones individually associated with at least one section of the container, and at 904 receiving a plurality of response signals from the arrangement of antenna coil sets, the plurality of response signals associated with an activated combination of antenna coils. The method further comprises, at 906 identifying at least one reading zone responsive to the activated combination of antenna coils, and at 908 based on the identified at least one reading zone, identifying a container section as the location of the item.

### Power Levels

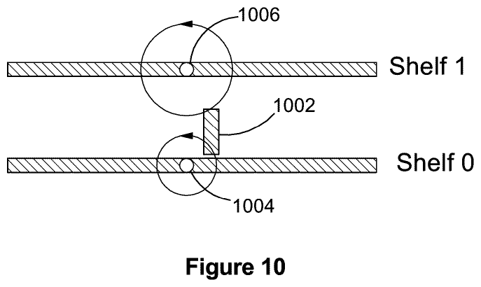

In a container that has multiple levels, such as multiple shelves or drawers, it may be that a reader antenna couples with a tag antenna that is either on the shelf above the antenna or on the shelf below the antenna. Referring to FIG. 10 for example, RFID tag 1002 affixed to an item on shelf 0 may be identified by the shelf 0 antenna 1004 as well as by the shelf 1 antenna 1006. In the illustrated example, the tag 1002 is identified at a lower field strength by the shelf 0 antenna 1004 than the higher field strength required for the shelf 1 antenna 1006 because the tag 1002 is closer to the shelf 0 antenna 1004.

In the exemplary non-limiting embodiment, the reader scans each antenna coil at multiple power levels, recording the lowest power level needed to sight each tag. As shown in FIG. 10, the lowest power level to sight tag 1002 is provided by shelf 0 antenna 1004 which is closer to the tag 1002. At the end of a complete scan (i.e., multiple power level scans by each antenna), the reader will have a set of one or more sightings of each tag at different power levels. The lowest power level indicates the most likely physical location of each tag in the exemplary non-limiting embodiment, because the antenna arrangements are provided in the floor of each level so that the tagged item resting on the floor will be closer to that shelf's antenna than to the antenna of the shelf above it. Each horizontal group of antenna coils is assigned a name that defines the relative position. This name is used when tag information is sent to the end user application.

Referring again to FIG. 1, in some non-limiting embodiments the antenna controller 106 activates each antenna coil 108 with a plurality of different power levels, and the processor 110 is further configured to receive a plurality of response signals associated with the plurality of power levels respectively, and determine a container height level of the item based on the received response signals.

Referring again to FIG. 9 of the drawings, optionally, in the method, activating the antenna coils 902 comprises activating each antenna coil with a plurality of different powers, receiving the plurality of response signals 904 comprises receiving response signals associated with each antenna coil and with each of the plurality of different powers, and identifying the container section 908 comprises, responsive to the plurality of response signals, determining in which height level of the container the item is located.

In this way, together with a combination of magnetic flux intensity control (through power level control) and a software decision making algorithm, the system is able to provide high resolution RFID tag location identification for multiple shelving system.

It is noted that the foregoing has outlined some of the more pertinent non-limiting embodiments. It will be clear to those skilled in the art that modifications to the disclosed non-non-limiting embodiment can be effected without departing from the spirit and scope thereof. As such, the described non-limiting embodiment ought to be considered to be merely illustrative of some of the more prominent features and applications. Other beneficial results can be realized by applying the non-limiting embodiments in a different manner or modifying them in ways known to those familiar with the art. This includes the mixing and matching of features. Elements and/or functions between various non-limiting embodiment(s) is expressly contemplated herein so that one of ordinary skill in the art would appreciate from this disclosure that features, elements and/or functions of one non-limiting embodiment may be incorporated into another non-limiting embodiment as appropriate, unless described otherwise, above. Although the description is made for particular arrangements and methods, the intent and concept thereof may be suitable and applicable to other arrangements and applications.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various non-limiting embodiments.

1. An RFID reader system for determining a section location of an electronically tagged item in a container with a plurality of sections and at the same time reducing a far field magnetic field strength, the system comprising:
an RF antenna array comprising an arrangement of overlapping antenna coils configured to create continuous reading zones individually associated with at least one section of the container; and
an RFID reader comprising:
an antenna controller configured to individually activate each antenna coil; and
a processor configured to:
receive, from the RF antenna array, a plurality of response signals associated with an activated combination of antenna coils,
identify at least one reading zone responsive to the activated combination of antenna coils, and
based on the identified at least one reading zone, identify a container section as the location of the item,
wherein the arrangement of overlapping antenna coils comprises:
a first loop arrangement comprising at least one first loop having a first current flow that causes a first magnetic field for detecting electronic tags in the near field; and
a second loop arrangement conductively connected to the first loop arrangement, the second loop arrangement comprising at least one second loop having a second current flow in a rotationally opposite direction to the first current flow, the second current flow causing a second magnetic field for detecting electronic tags in the near field,
wherein the first loop arrangement is configured to have a first inner area and the second loop arrangement is configured to have a second inner area so that the first magnetic field reduces the second magnetic field in the far field.

2. The RFID reader system of claim 1, wherein the RF antenna array comprises:
a first series of coplanar antenna coils, each coil comprising one or more coil loops, wherein the antenna coils are arranged to overlap so that the loops are aligned along a first axis, thereby generating, along the first axis, a first continuous reading zone comprising a series of interleaved reading zones generated by the coil loops of the first series;
a second series of coplanar antenna coils, each coil comprising one or more coil loops, wherein the antenna coils are arranged to overlap so that the loops are aligned along a second axis, thereby generating, along the second axis, a second continuous reading zone comprising a series of interleaved reading zones generated by the coil loops of the second series,
wherein the second axis is parallel to and spaced apart from the first axis so that the first and second continuous reading zones partially overlap to form a third continuous reading zone.

3. (canceled)

4. The RFID reader system of claim 1, wherein the first and second magnetic fields are in opposite directions so that a sum of the first magnetic field and the second magnetic field is substantially zero in the far field.

5. The RFID reader system of claim 1, wherein the first loop arrangement and the second loop arrangement form a sequence of spaced antenna loops, the spaced antenna loops producing reading zones of substantially uniform magnetic field strength.

6. The RFID reader system of claim 5, wherein the at least one first loop is sized differently to the at least one second loop so that the first inner area is substantially the same as the second inner area.

7. The RFID reader system of claim 5, wherein the sequence comprises an uneven number of antenna loops.

8. The RFID reader system of claim 5, wherein the sequence comprises two antenna loops in a figure of eight structure wherein the two antenna loops have a substantially similar inner area.

9. The RFID reader of claim 8, wherein the first series comprises two overlapping figure of eight antenna coils, and the second series comprises two overlapping figure of eight antenna coils, and wherein the first continuous reading zone is associated with a first and a second container section, the second continuous reading zone is associated with the second container section and a third container section, so that the third continuous reading zone is associated with the second container section.

10. The RFID reader system of claim 1, wherein the number of loops and the inner area of the loops cause the sum of the first magnetic field and the second magnetic field to be substantially zero in the far field.

11. The RFID reader system of claim 1, wherein each continuous reading zone comprises a series of interleaved reading zones generated by the antenna coils.

12. The RFID reader system of claim 1, wherein the continuous reading zones are configured to have a magnetic field orientation to detect electronic tags in a predetermined upright orientation.

13. The RFID reader system of claim 1, wherein the RF antenna array comprises a plurality of laterally overlapping series of antenna coils so that the series are aligned along a length of the sections of the container, and so that the array is positioned across the plurality of sections.

14. The RFID reader system of claim 1, wherein:
the antenna controller activates each antenna coil with a plurality of power levels, and
the processor is further configured to:
receive a plurality of response signals associated with the plurality of power levels respectively, and
determine a container height level of the item based on the received response signals.

15. A method of determining, with an RFID reader, a section location of an electronically tagged item within sections of a container and at the same time reducing a far field magnetic field strength, the method comprising:
providing antenna coils in an arrangement of overlapping antenna coils that are configured to create continuous reading zones individually associated with at least one section of the container, wherein the arrangement of overlapping antenna coils comprises:
a first loop arrangement comprising at least one first loop having a first current flow that causes a first magnetic field for detecting electronic tags in the near field; and
a second loop arrangement conductively connected to the first loop arrangement, the second loop arrangement comprising at least one second loop having a second current flow in a rotationally opposite direction to the first current flow, the second current flow causing a second magnetic field for detecting electronic tags in the near field,
wherein the first loop arrangement is configured to have a first inner area and the second loop arrangement is configured to have a second inner area so that the first magnetic field reduces the second magnetic field in the far field;
individually activating the antenna coils to locate the tagged item;
receiving a plurality of response signals from the arrangement of antenna coils, the plurality of response signals associated with an activated combination of antenna coils;
identifying at least one reading zone responsive to the activated combination of antenna coils, and
based on the identified at least one reading zone, identifying a container section as the location of the item.

16. The method of claim 15, wherein:
activating the antenna coils comprises activating each antenna coil with a plurality of different powers;
receiving the plurality of response signals comprises receiving response signals associated with each antenna coil for each of the plurality of different powers; and
identifying the container section comprises:
responsive to the plurality of response signals, determining in which height level of the container the item is located.

17. (canceled)

18. (canceled)

19. The RFID reader system of claim 1, wherein the first loop arrangement and the second loop arrangement are substantially coplanar.

20. The RFID reader system of claim 1, wherein the first loop arrangement and the second loop arrangement form a sequence of spaced antenna loops.

21. The RFID reader system of claim 1, wherein the sequence comprises two antenna loops in a figure of eight structure wherein the two antenna loops have a substantially similar inner area.

22. The RFID reader system of claim 1, wherein the sequence comprises an uneven number of antenna loops.

23. The RFID reader system of claim 1, wherein the at least one first loop is sized differently to the at least one second loop so that the first inner area is substantially the same as the second inner area.
